(19) United States
(12) Patent Application Publication
(10) Pub. No.: US 2015/0082278 A1
(43) Pub. Date: Mar. 19, 2015

(54) CLONE DETECTION METHOD AND CLONE FUNCTION COMMONALIZING METHOD

(71) Applicant: AISIN AW CO., LTD., Anjo-shi (JP)

(72) Inventor: Takayuki KUBO, Anjo (JP)

(21) Appl. No.: 14/461,811

(22) Filed: Aug. 18, 2014

(30) Foreign Application Priority Data
Sep. 13, 2013 (JP) 2013-190692

(51) Int. Cl. G06F 9/44

(52) U.S. Cl. CPC G06F 8/751
USPC 717/123

(57) ABSTRACT

A clone detection method including a detection step of detecting at least a plurality of subsystems, functions of which can be commonalized, from a model constituted by a block diagram and having a plurality of subsystems each composed of an input port, an output port, and a block connected between the input port and the output port, the detection step being performed by a control section.

### INCORPORATION BY REFERENCE

The disclosure of Japanese Patent Application No. 2013-190692 filed on Sep. 13, 2013 including the specification, drawings and abstract is incorporated herein by reference in its entirety.

### BACKGROUND OF THE INVENTION

The present invention relates to a method of detecting clones from a model constituted by a block diagram and a clone function commonalizing method, for example, and more particularly to a method of detecting clones from a model constituted by a block diagram and a clone function commonalizing method by which portions with similar configurations due to copying of a block or the like can be detected.

### DESCRIPTION OF THE RELATED ART

Hitherto, Simulink (registered trademark), which is one of MATLAB (registered trademark) series products of MathWorks, has been known as software for generating a source code for providing a command to a computer. When a user inputs to the Simulink information on a demand document and a design document as design specifications as a model constituted by a block diagram, the model is automatically coded into a programming language (C language) so that a source code is automatically prepared.

When the Simulink prepares a source code from a model constituted by a block diagram, blocks which are minimum units constituting the model are disposed one by one, and a group of blocks (hereinafter referred to as a “subsystem”) having an input port and an output port and having a predetermined function is often copied and pasted at another location as it is or after being modified as appropriate. Presence of such subsystems with similar configurations (hereinafter referred to as “clones”) prepared by copying and pasting may result in a large number of overlapping portions in the source code when the entire model constituted by a block diagram is coded, because the clones have similar source codes.

In actual products, the source code is stored in a ROM, for example. Because the ROM is desired to have a small capacity, a reduction in size of the source code is desired. Therefore, there is developed a diagnosis device that diagnoses the presence or absence of clones before a model constituted by a block diagram is coded (see Japanese Patent Application Publication No. 2012-38022 (JP 2012-38022 A)). The diagnosis device indicates the location of overlapping portions when a model constituted by a block diagram is coded, and thus allows the size of the source code to be reduced by redesigning the block diagram on the basis of the diagnosis results.

In addition, the diagnosis device excludes an input port and an output port of a subsystem, and determines the presence or absence of clones on the basis of connection between a block inside the subsystem and blocks before and after the subsystem. This allows exhaustive detection of clones from the entire model irrespective of the boundary between the subsystems.

### SUMMARY OF THE INVENTION

However, the diagnosis device according to JP 2012-38022 A is intended to exhaustively detect clones from the entire model, and thus it is not considered to reduce the size of the source code by commonalizing the functions of the detected clones. Therefore, in the clone detection process, clones are detected with blocks inside and outside a subsystem excluding an input port and an output port connected, and even portions, function of which cannot be commonalized because of the absence of an input port and an output port, are detected as clones, which results in wasteful detection results.

On the other hands, portions, functions of which can be commonalized with an easy correction, such as similar blocks that differ only in parameter, for example, may be strictly determined as not being clones, and the size of the source code may not be sufficiently reduced.

It is therefore an object of the present invention to provide a method of detecting clones from a model constituted by a block diagram and a clone function commonalizing method that enable better detection of only clones, functions of which can be commonalized, to reduce the size of a source code.

A clone detection method according to a first aspect of the present invention (see FIGS. 2 and 7, for example) includes a detection step of detecting at least a plurality of subsystems, functions of which can be commonalized, from a model constituted by a block diagram and having a plurality of subsystems each composed of an input port, an output port, and a block connected between the input port and the output port, the detection step being performed by a control section.

The clone detection method according to a second aspect of the present invention (see FIGS. 2 and 7, for example) further includes an output step of outputting results of the detection performed in the detection step, the output step being performed by the control section.

In the clone detection method according to a third aspect of the present invention (see FIG. 3, for example), the detection step performed by the control section includes extracting a plurality of subsystems, functions of which can be commonalized with a function of a candidate for a subsystem registered in a library, from the model as the plurality of subsystems, functions of which can be commonalized.

In the clone detection method according to a fourth aspect of the present invention (see FIG. 3, for example), the library includes subsystems set in advance separately from the model.

In the clone detection method according to a fifth aspect of the present invention (see FIG. 3, for example), the library includes a plurality of subsystems, functions of which can be commonalized, the plurality of subsystems being extracted from the model and registered in the library by the control section.

In the clone detection method according to a sixth aspect of the present invention (see FIGS. 6A and 6B, for example), the detection step performed by the control section includes detecting a plurality of subsystems with the same function as the plurality of subsystems, functions of which can be commonalized.

In the clone detection method according to a seventh aspect of the present invention (see FIGS. 5A and 5B, for example), the detection step performed by the control section includes detecting a plurality of subsystems having respective blocks, functions of which can be commonalized by changing a parameter, as the plurality of subsystems, functions of which can be commonalized.

In the clone detection method according to an eighth aspect of the present invention (see FIG. 4, for example), the detection step performed by the control section includes detecting a plurality of subsystems having respective blocks that are the same in number of input and output ports but that are different only in operator as a plurality of subsystems, functions of which cannot be commonalized.

In the clone detection method according to a ninth aspect of the present invention, the detection step performed by the control section includes detecting a plurality of subsystems having respective blocks with different data types as a plurality of subsystems, functions of which cannot be commonalized.

In the clone detection method according to a tenth aspect of the present invention, the detection step performed by the control section includes deleting a block that does not affect a function from each subsystem in the model before detecting a plurality of subsystems, functions of which can be commonalized.

In the clone detection method according to an eleventh aspect of the present invention, the detection step performed by the control section includes in the case where the plurality of subsystems in the model have a hierarchical structure and it is detected that functions of the subsystems in different levels can be commonalized, deleting subsystems in levels other than the uppermost level from the detection results so that only a subsystem in the uppermost level remains in the detection results.

In the clone detection method according to a twelfth aspect of the present invention (see FIG. 2, for example), the detection results include predetermined information about a determination as to whether or not functions of subsystems can be commonalized.

A clone detection program according to a thirteenth aspect of the present invention (see FIG. 1, for example) causes a computer to execute the steps of the clone detection method according to any one of the first to twelfth aspects.

A computer-readable recording medium according to a fourteenth aspect of the present invention stores the clone detection program that causes a computer to execute the steps of the clone detection method according to the thirteenth aspect.

A clone function commonalizing method according to a fifteenth aspect of the present invention (see FIG. 2, for example) includes:

the steps of the clone detection method according to any one of the first to twelfth aspects; and

a function commonalizing step of setting a plurality of subsystems, which are at least some of the subsystems detected in the detection step as the plurality of subsystems, functions of which can be commonalized, such that functions of the at least some of the subsystems are commonalized when coded, the step being performed by the control section.

A clone function commonalizing program according to a sixteenth aspect of the present invention (see FIG. 1, for example) causes a computer to execute the steps of the clone function commonalizing method according to the fifteenth aspect.

A computer-readable recording medium according to a seventeenth aspect of the present invention stores the clone function commonalizing program that causes a computer to execute the steps of the clone function commonalizing method according to the sixteenth aspect.

According to the first aspect of the present invention, the clone detection method includes a detection step of detecting at least a plurality of subsystems, functions of which can be commonalized, from a model constituted by a block diagram. Thus, the functions of the detected subsystems, functions of which can be commonalized, that is, the functions of clones, can be commonalized. Consequently, the size of the source code can be reduced when the model is coded.

According to the second aspect of the present invention, the clone detection method further includes an output step of outputting results of the detection performed in the detection step. Thus, the detection results can be indicated to the user, which allows the user to select clones, functions of which to be commonalized, as appropriate on the basis of the detection results. In addition, even functions of clones, functions of which it is determined cannot be commonalized, can be processed by the user as appropriate to be commonalized. Consequently, functions of clones can be adequately commonalized through verification by the user, and thus the size of the source code can be more effectively reduced.

According to the third aspect of the present invention, a plurality of subsystems, functions of which can be commonalized with a function of a candidate for a subsystem registered in a library, are extracted from the model as clones, functions of which can be commonalized. Thus, the processing time for detecting clones can be shortened compared to a case where the library is not utilized.

According to the fourth aspect of the present invention, the library is set in advance separately from the model. Thus, subsystems verified in advance can be utilized. Consequently, it is not necessary to verify the subsystems when verifying whether the model in which clones have been replaced for function commonalization maintains its original function. Therefore, the verification time can be shortened, and the overall processing time can be shortened.

According to the fifth aspect of the present invention, the library is prepared automatically. Thus, automation of detection of clones can be promoted.

According to the sixth aspect of the present invention, a plurality of subsystems with the same function are detected as the subsystems, functions of which can be commonalized. Thus, functions of a larger number of clones can be commonalized compared to a case where subsystems with the same function but with different configurations are determined as subsystems, functions of which cannot be commonalized. Consequently, the size of the source code can be further reduced when the model is coded.

According to the seventh aspect of the present invention, a plurality of subsystems, functions of which can be commonalized by changing a parameter, are detected as the subsystems, functions of which can be commonalized. Thus, functions of a larger number of clones can be commonalized compared to a case where such subsystems are determined as subsystems, functions of which cannot be commonalized without changing a parameter. Consequently, the size of the source code can be further reduced when the model is coded.

According to the eighth aspect of the present invention, a plurality of subsystems that are the same in number of input and output ports but that are different only in operator are detected as subsystems, functions of which cannot be commonalized. Thus, it is possible to prevent subsystems, functions of which cannot be commonalized, from being erroneously detected as the subsystems, functions of which can be commonalized, and the processing time for detecting clones can be shortened.

According to the ninth aspect of the present invention, a plurality of subsystems with different data types are detected as subsystems, functions of which cannot be commonalized. Thus, it is possible to prevent subsystems, functions of which cannot be commonalized, from being erroneously detected as the subsystems, functions of which can be commonalized, and the processing time for detecting clones can be shortened.

According to the tenth aspect of the present invention, a block that does not affect a function is deleted before detecting subsystems, functions of which can be commonalized. Thus, even functions of subsystems with different configurations due to the presence of a block that does not affect a function may be commonalized. Consequently, functions of a larger number of clones can be commonalized, and the size of the source code can be further reduced when the model is coded.

According to the eleventh aspect of the present invention, subsystems in levels other than the uppermost level are deleted from the detection results so that only a subsystem in the uppermost level remains in the detection results. Thus, preparation of overlapping source codes by coding subsystems in different levels can be prevented. Therefore, the size of the source code can be further reduced when the model is coded.

According to the twelfth aspect of the present invention, the detection results include predetermined information about a determination as to whether or not functions of subsystems can be commonalized. Thus, the user can reference the detection results to determine whether or not to commonalize functions of subsystems. Consequently, functions of clones can be adequately commonalized through verification by the user, and thus the size of the source code can be more effectively reduced.

According to the thirteenth aspect of the present invention, a computer is caused to execute the steps of the clone detection method according to any of the first to twelfth aspects. Thus, clones, functions of which can be commonalized, can be detected by the computer, and the size of the source code can be reduced when the model is coded.

According to the fourteenth aspect of the present invention, the clone detection program is recorded in a recording medium. Thus, clones, functions of which can be commonalized, can be detected by a computer that reads and executes the program, and the size of the source code can be reduced when the model is coded.

According to the fifteenth aspect of the present invention, functions of a plurality of subsystems, which are at least some of the subsystems detected as the plurality of subsystems, functions of which can be commonalized, can be commonalized when coded. Consequently, the size of the source code can be reduced when the model is coded.

According to the sixteenth aspect of the present invention, a computer is caused to execute the steps of the clone function commonalizing method according to the fifteenth aspect. Thus, functions of clones can be commonalized by the computer, and the size of the source code can be reduced when the model is coded.

According to the seventeenth aspect of the present invention, the clone function commonalizing program is recorded in a recording medium. Thus, functions of clones can be commonalized by a computer that reads and executes the program, and the size of the source code can be reduced when the model is coded.

### BRIEF DESCRIPTION OF THE DRAWINGS

FIG. 1 is a schematic diagram illustrating a clone function commonalizing device according to an embodiment of the present invention;

FIG. 2 is a flowchart illustrating a procedure of processes performed by the clone function commonalizing device according to the embodiment of the present invention;

FIG. 3 illustrates a main screen of the clone function commonalizing device according to the embodiment of the present invention;

FIG. 4 illustrates a case where operators for blocks are different so that functions of subsystems cannot be commonalized in a function commonalizing process performed by the clone function commonalizing device according to the embodiment of the present invention;

FIGS. 5A and 5B illustrate a case where subsystems have the same configuration but different parameter constants so that the functions of the subsystems can be commonalized in the function commonalizing process performed by the clone function commonalizing device according to the embodiment of the present invention, in which FIG. 5A illustrates a case with gain a and FIG. 5B illustrates a case with gain b;

FIGS. 6A and 6B illustrate a case where subsystems have different configurations but the same function so that the functions of the subsystems can be commonalized in the function commonalizing process performed by the clone function commonalizing device according to the embodiment of the present invention, in which FIG. 6A illustrates a case corresponding to min block and FIG. 6B illustrates a case corresponding to max block; and

FIG. 7 illustrates a flow in which an unprocessed model is processed into a processed model by the clone function commonalizing device according to the embodiment of the present invention.

### DETAILED DESCRIPTION OF THE EMBODIMENTS

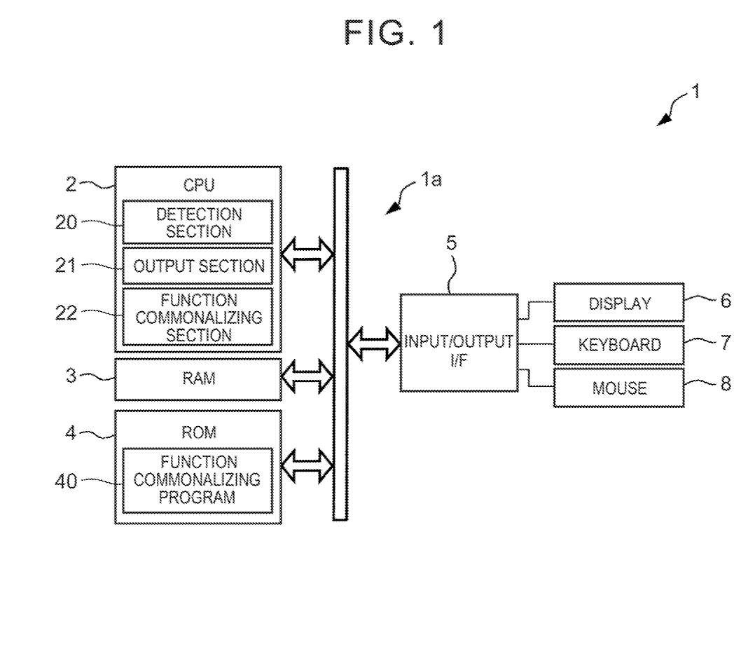

The configuration of a clone function commonalizing device 1 that executes a clone function commonalizing method according to an embodiment of the present invention will be described below with reference to FIG. 1. The clone function commonalizing device 1 according to the embodiment is implemented by a computer, for example, and executes a clone function commonalizing method by executing a clone function commonalizing program 40 to be discussed later.

As illustrated in FIG. 1, the computer which constitutes the clone function commonalizing device 1 includes a CPU 2 that serves as a control section, a RAM 3, a ROM 4 that serves as a recording medium, an input/output interface circuit (I/F) 5, a display 6, a keyboard 7, and a mouse 8. Among these, the CPU 2, the RAM 3, the ROM 4, and the input/output interface circuit 5 are connected to each other through a bus to constitute a computer main unit 1a. In the embodiment, the computer which constitutes the clone function commonalizing device 1 is also used as a clone detection device.

The CPU 2 is a central processing unit that executes a program stored in the ROM 4 to perform various operations and control various sections of the clone function commonalizing device 1. The CPU 2 includes a detection section 20, an output section 21, and a function commonalizing section 22. The CPU 2 performs control so as to execute various steps of a clone function commonalizing method to be discussed later.

The detection section 20 detects at least a plurality of subsystems, functions of which can be commonalized, from a model constituted by a block diagram. The output section 21 outputs the results of the detection performed by the detection section 20. The function commonalizing section 22 sets a plurality of subsystems, which are at least some of the subsystems detected by the detection section 20 as the plurality of subsystems, functions of which can be commonalized, such that functions of the at least some of the subsystems are commonalized when coded.

The RAM 3 is a random access memory that provides the CPU 2 with a working memory, and reads and temporarily stores the clone function commonalizing program 40 to be executed.

The ROM 4 is a memory that stores various programs for controlling various sections, and stores the clone function commonalizing program 40, for example. In the embodiment, the various programs are stored in the ROM 4. However, the present invention is not limited thereto, and the various programs may be stored in other external storage devices such as a hard disk drive, for example.

In the embodiment, the clone function commonalizing program 40 includes a clone detection program as a part thereof. Therefore, when the CPU 2 executes the clone function commonalizing program 40 to perform a clone function commonalizing method, the clone detection program is executed as a part of the clone function commonalizing program 40 to perform a clone detection method.

The input/output interface circuit 5 enables communication between the computer main unit 1a and other devices. In the embodiment, for example, the input/output interface circuit 5 enables communication between the computer main unit 1a and the display 6, the keyboard 7, and the mouse 8. The display 6 is constituted by a liquid crystal display, for example, and outputs and displays the detection results output from the output section 21.

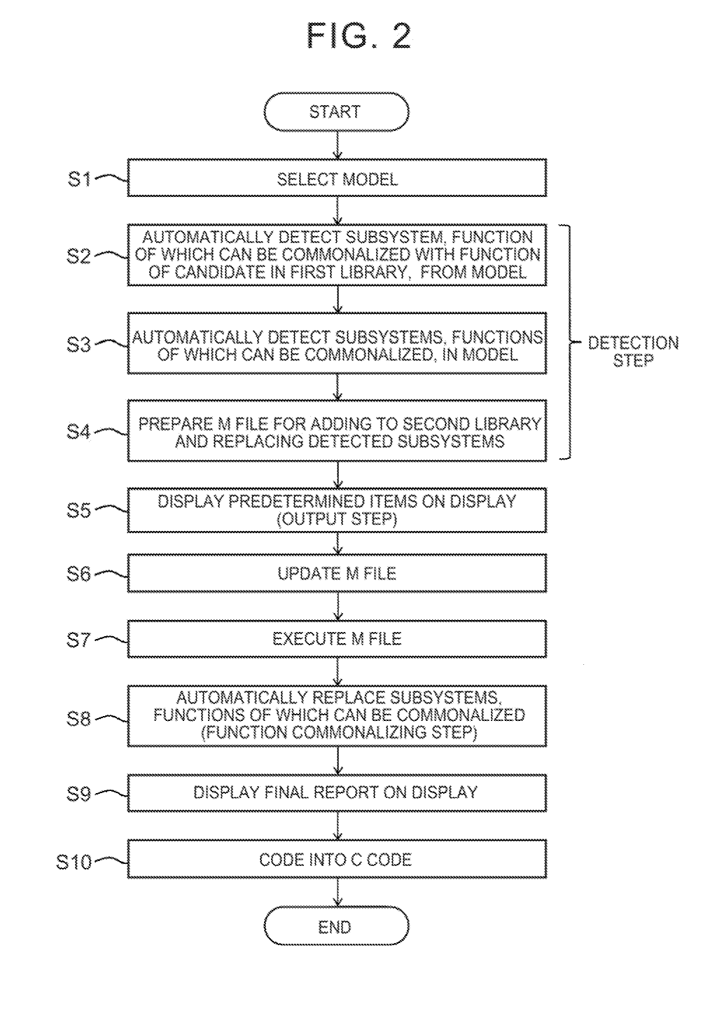

Operation caused when the clone function commonalizing device 1 discussed above performs the clone function commonalizing method will be described with reference to the flowchart illustrated in FIG. 2.

A user prepares a model constituted by a block diagram on a computer utilizing the Simulink, for example. The model constituted by a block diagram has a plurality of subsystems each composed of an input port, an output port, and a block connected between the input port and the output port.

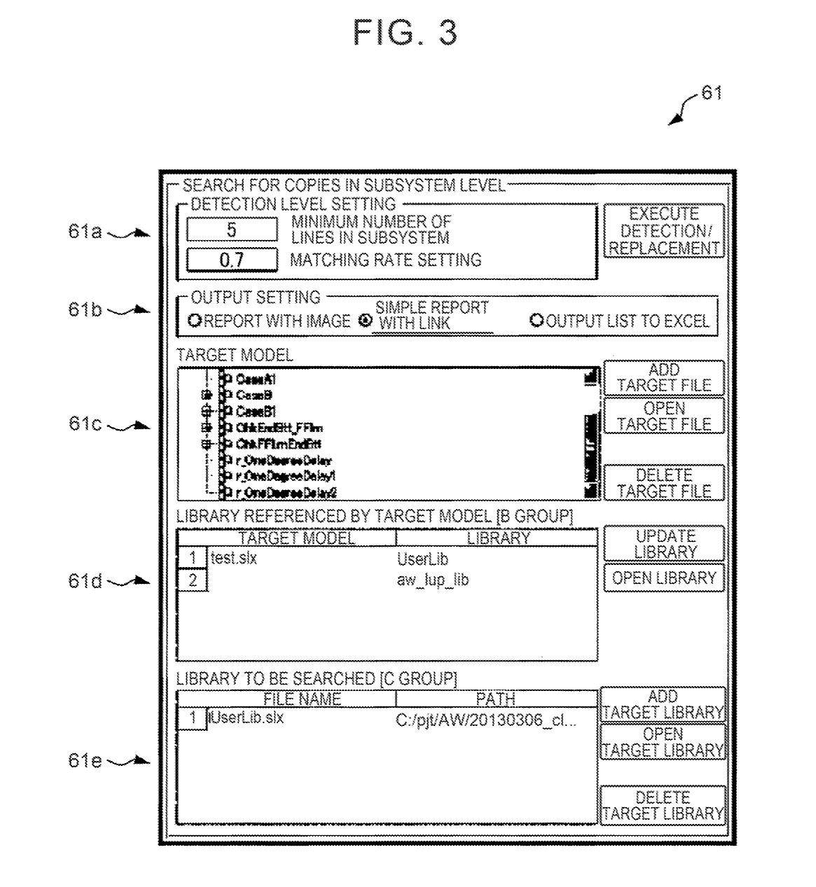

When the clone function commonalizing device 1 is actuated after the model is prepared, a main screen 61 is displayed on the display 6 as illustrated in FIG. 3. A detection level setting section 61a, an output setting section 61b, a target model display section 61c, a first library display section 61d, and a second library display section 61e are displayed on the main screen 61.

In the detection level setting section 61a, the user sets the detection level (scale) of subsystems to be detected from the model. The setting is performed utilizing the keyboard 7 and the mouse 8 of the clone function commonalizing device 1. In the embodiment, the criteria for setting the level include the minimum number of lines in the subsystem, and the configuration matching rate among all the lines. Because the minimum number of lines can be set, it is possible to prevent an increase of the RAM and a reduction in processing speed due to overhead for calling a function because the number of lines to be detected is so small as to cause frequent access to the function. The configuration matching rate among all the lines is obtained by comparing the numbers of lines in blocks connected to each other obtained by decomposing the subsystem, and calculating the rate of the number of lines in the connected blocks with the same configuration among the number of all the lines. The criteria for setting the level are not limited thereto, and the number of blocks may be utilized, for example.

Next, in the output setting section 61b, the user sets the items to be indicated in reports to be output later. In the clone function commonalizing device 1, as discussed later, the reports are output twice, that is, when automatic detection of subsystems is finished (step S5) and when function commonalization is finished (step S9). The items to be indicated include the name of the target subsystem in the model, the name of a subsystem in a library compared with the target subsystem, the configuration matching rate between the subsystems, a diagram of the subsystems in the case of a report with an image, etc. It is a matter of course that the items to be indicated are not limited thereto.

Next, in the target model display section 61c, the user adds a target model to select a target model for clone detection (step S1). In the target model display section 61c, subsystems included in the selected model are displayed in the tree view.

Meanwhile, the user prepares a first library in advance, and has an appropriate number of verified subsystems registered as candidates. The name of the first library (in FIG. 3, UserLib) and the name of the linked model are displayed in the first library display section 61d. In addition, the name of a second library to be discussed later is displayed in the second library display section 61e.

When the clone function commonalizing device 1 executes the clone function commonalizing program 40, the detection section 20 selects the subsystems as the candidates from the first library in the order set by the user, and automatically detects subsystems, functions of which can be commonalized with the functions of the selected subsystems, from the selected model (step S2). After automatic detection performed using the candidates in the first library is finished, the detection section 20 searches the model to automatically detect subsystems, functions of which can be commonalized (step S3). That is, in the embodiment, it is determined whether or not functions of subsystems can be commonalized with priority given to the existing first library set by the user. Consequently, the verification time can be effectively shortened as discussed later.

An example of the method of determining whether or not functions of subsystems can be commonalized performed by the detection section 20 in step S2 and step S3 will be described. The phrase “(subsystems) functions of which can be commonalized” as used herein includes not only a case where the clone function commonalizing device 1 automatically commonalizes the functions of the subsystems, but also a semi-automatic case where an interim report indicating subsystems detected by the clone function commonalizing device 1 as subsystems, functions of which can be commonalized, is output to allow the user to determine whether the functions of the subsystems can be commonalized. The following method of determining whether or not functions of subsystems can be commonalized is merely exemplary, and it is a matter of course that the present invention is not limited thereto.

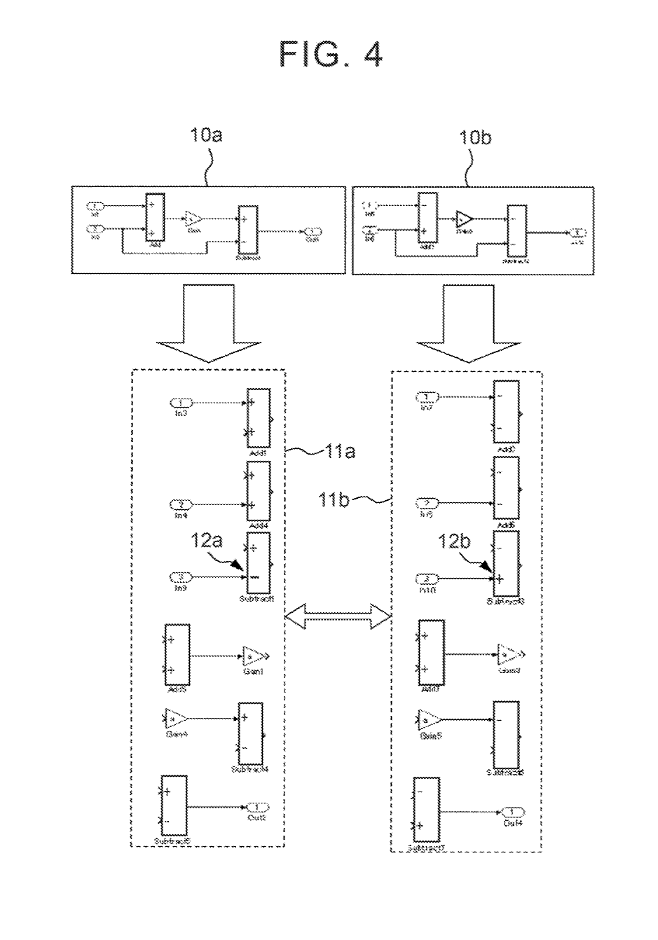

For example, as illustrated in FIG. 4, in the case where the detection section 20 determines whether or not functions of a subsystem 10a and a subsystem 10b can be commonalized, the subsystems 10a and 10b are decomposed into connection relationships 11a and 11b, respectively, composed of connections between two blocks. In the example illustrated in FIG. 4, the subsystems 10a and 10b have the same configuration in terms of having three connections between an input block and an addition block, two connections between an addition block and a gain block, and one connection between an addition block and an output block. If a determination is made only on the basis of the connection between the blocks, it may be determined that the functions of the subsystems 10a and 10b can be commonalized. However, some of addition blocks, 12a and 12b, connected to an input block have opposite operators to provide different calculation results, and therefore the functions of the subsystems 10a and 10b cannot be commonalized. Characters that are directly written in the C language, such as operators for addition, subtraction, multiplication, division, logical operation, and comparison operation, for example, are also treated in the same manner. Thus, the clone function commonalizing device 1 according to the embodiment can strictly check the content of a process performed by a connected block to determine whether or not functions of subsystems can be commonalized.

In addition, if the detection section 20 determines whether or not functions of subsystems can be commonalized only on the basis of the configuration of the blocks, for example, a difference in type of data may not be detected. A difference in data type indicates a difference in size of the passage for the data. Because the names of the functions are different, the functions of the subsystems cannot be commonalized. Thus, the clone function commonalizing device 1 according to the embodiment detects not only the configuration of the blocks but also the type of input and output data to determine whether or not functions of subsystems can be commonalized on the basis of the identity of the data type.

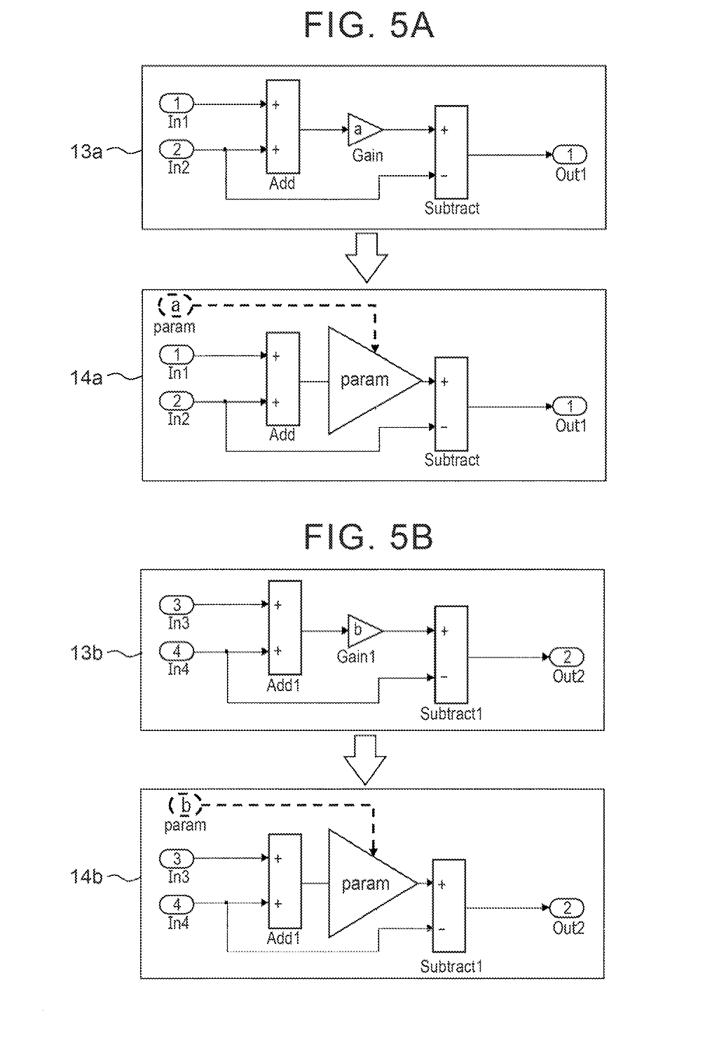

In addition, functions of subsystems cannot be commonalized also in the case where the blocks contain a statement indicating that the results are directly delivered to a global signal, for example. That is, functions of characters that are directly written in the C language level cannot be commonalized. Thus, if there is a global variable that can be removed and the global variable is removed, functions of subsystems can be commonalized. Specifically, as illustrated in FIGS. 5A and 5B, subsystems 13a and 13b have a gain block with gains a and b, respectively, and have different block configurations with different parameters. In this case, it may be determined that the functions of the subsystems cannot be commonalized. Because a difference in numerical parameter is neither a functional difference nor a difference in data size, unlike a difference in operator, the clone function commonalizing device 1 according to the embodiment absorbs such a difference to commonalize the functions of the subsystems. Specifically, as indicated by subsystems 14a and 14b, functions of which have been commonalized, the subsystems 14a and 14b are identified by providing the parameters with a common name and setting pseudo-input arguments a and b for passing data with the common name to the model. After that, setting for function commonalization is automatically made. In this way, even if constants that can be treated as arguments, called “adjustable parameters”, are different between the blocks, the functions of the subsystems can be commonalized by changing the constants using a mask parameter.

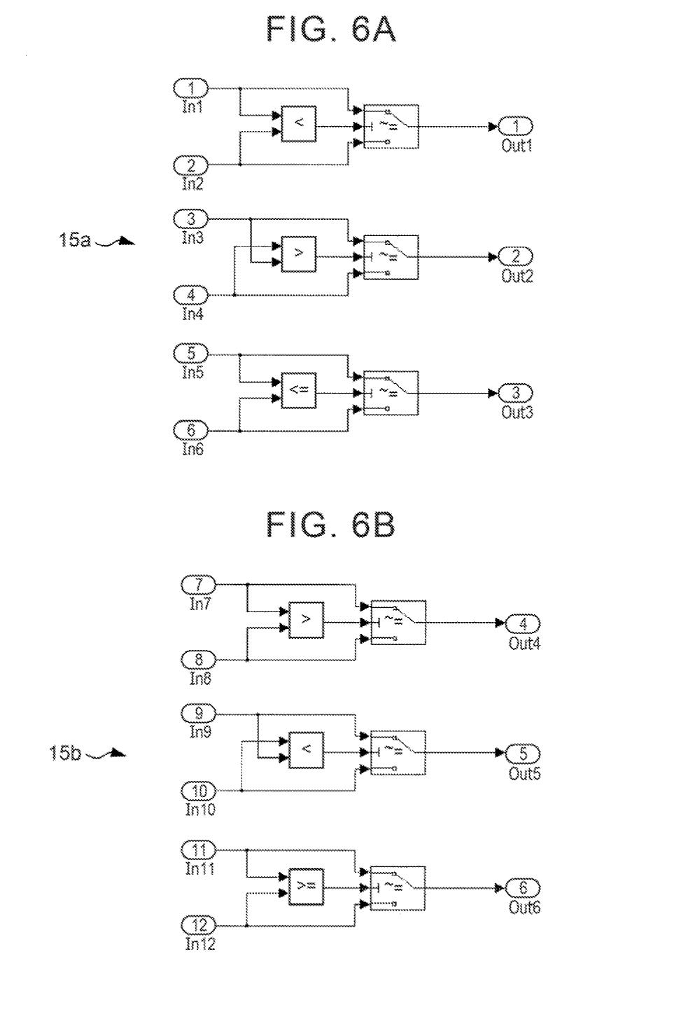

In addition, as illustrated in FIGS. 6A and 6B, for example, the detection section 20 may automatically detect candidates for replacement with the MinMax block using a combination of the Switch block and the Relational Operator block. Specifically, as illustrated in FIG. 6A, each subsystem 15a has a function corresponding to the min block, which can be replaced with the MinMax block. As illustrated in FIG. 6B, meanwhile, each subsystem 15b has a function corresponding to the max block, which can be replaced with the MinMax block. Likewise, candidates for replacement with the Detect Change block, the Detect Increase block, and the Detect Decrease block can be automatically detected using a combination of the Relational Operator block and the Unit Delay block, and candidates for replacement with the Interval Test block can be automatically detected using a combination of the Logical Operator block, the Relational Operator block, and the Constant block.

In addition, a list of blocks that may be deleted from subsystems in a model is set in advance, and the relevant blocks are automatically deleted when a list of subsystems in a model is prepared. For example, signal information blocks such as the Data Type Conversion block and the Signal Conversion block and blocks exclusively for signal definition such as the Data Type Duplicate block do not affect the function of subsystems, and thus are automatically deleted when a list is prepared. In addition, for blocks that are not directly coupled to each other such as the From block and the Goto block which are apart from but connected to each other, the blocks are deleted and automatically converted into direct connection. For example, for A-Goto(X) and From(X)-B, the From block and the Goto block are deleted and converted into A-B.

In addition, when the detection section 20 determines whether or not functions of subsystems can be commonalized, not only the block type but also other comparison parameters (optional) may be utilized. For example, for logical operation blocks, an operator of each block has a great influence, and thus the name of the operator is set as an option. Specifically, the Logic block is indicated with an option for an operator as a parameter, and indicated as Logic(AND), Logic(OR), Logic(NOT), etc. in accordance with the type of the operator for logical operation such as AND, OR, NOT, etc., for example. Meanwhile, the Lookup_n-D block is indicated with an option for an order as a parameter, and indicated as Lookup_n-D(1), Lookup_n-D(2), Lookup_n-D(3), etc., for example.

In addition, there is a case where target subsystems in a model have a hierarchical structure and it is detected that the functions of the subsystems in different levels can be commonalized with a function of a subsystem in a library. In this case, the detection section 20 deletes subsystems in levels other than the uppermost level from the detection results so that only a subsystem in the uppermost level remains in the detection results. Consequently, preparation of overlapping source codes by coding subsystems in different levels can be prevented. For example, in the case where a subsystem B is contained in a subsystem A, it is necessary to first make setting for function commonalization for the subsystem B, and to thereafter make setting for function commonalization for the subsystem A. In the case where functions cannot be commonalized for the subsystem B, it is necessary to design a mask subsystem for the subsystem A with consideration also given to a parameter for the subsystem B.

The detection section 20 additionally registers the subsystem automatically detected in step S3 in a second library (see the second library display section 61e in FIG. 3). Further, the detection section 20 prepares an M file for replacing a subsystem automatically detected in a model utilizing the subsystem additionally registered in the second library (step S4). The M file is a program prepared in the M language. When the M file is executed, the additional registration and the replacement discussed above are executed. Step S2 to step S4 correspond to the detection step and the clone detection method according to the present invention.

The output section 21 displays predetermined items on the display 6 as an interim report (step S5, output step). In this step, the M file prepared in step S4 is displayed, for example, and the user edits the M file to provide a command to the clone function commonalizing device 1. The predetermined items to be indicated include the name, parameter, etc. of subsystems that are determined by the clone function commonalizing device 1 to be completely identical, the name, parameter, etc. of subsystems that are determined by the clone function commonalizing device 1 to be not completely identical but, functions of which the clone function commonalizing device 1 determines can be commonalized because of the same function or the like, and the name, parameter, etc. of subsystems that are extracted from a model by the clone function commonalizing device 1 but, functions of which the clone function commonalizing device 1 does not determine can be commonalized with a function of a subsystem in a library. In addition, the matching rate for each block and the matching rate between subsystems are also displayed. Further, the display also makes it possible to display and select whether or not an observation signal is output in the case where the only difference between clones is observation information on a measured signal. It is a matter of course that the predetermined items are not limited thereto.

The user references the display 6 on which the M file including the predetermined items is displayed, and updates the M file by selecting subsystems, functions of which are to be actually commonalized, from the subsystems, functions of which the clone function commonalizing device 1 determines can be commonalized, or changing some of the subsystems, functions of which the clone function commonalizing device 1 determines cannot be commonalized, into subsystems, functions of which can be commonalized, through parameter conversion or the like (step S6).

Further, when the update of the M file is finished, the user executes the M file (step S7). Through the execution of the M file, the function commonalizing section 22 automatically replaces subsystems, functions of which can be commonalized, with common subsystems (step S8, function commonalizing step). That is, the clone function commonalizing device 1 automatically replaces a plurality of subsystems selected by the user, which are at least some of the plurality of subsystems detected as subsystems, functions of which can be commonalized, and displayed in the interim report, such that functions of the at least some of the plurality of subsystems are commonalized when coded.

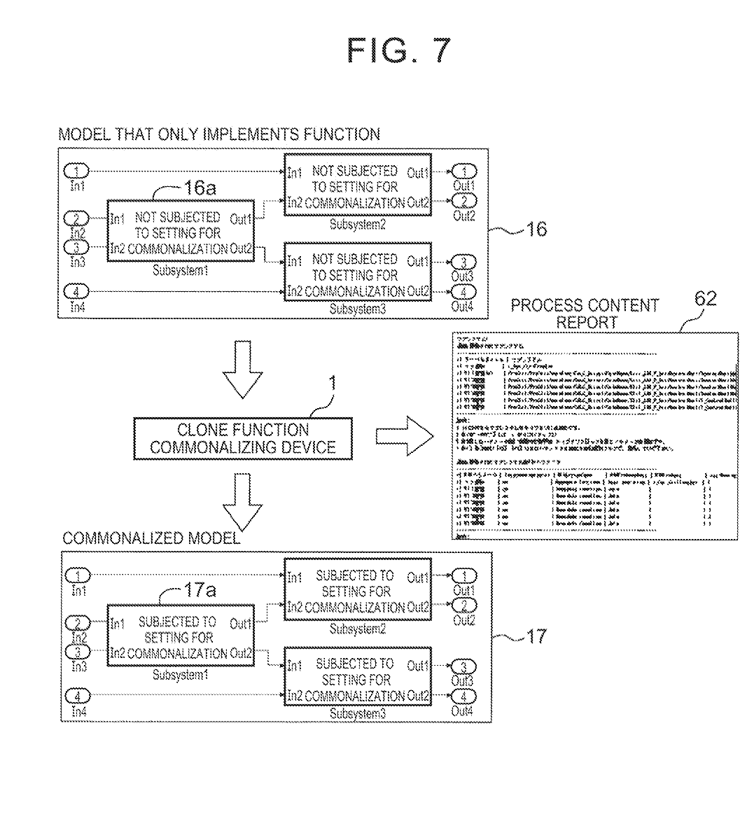

As illustrated in FIG. 7, the clone function commonalizing device 1 receives an unprocessed model 16 selected by the user through the process in step S1 and makes setting for commonalizing functions of subsystems through the processes in step S2 to step S8 to prepare a commonalized model 17. At this time, the clone function commonalizing device 1 automatically replaces subsystems 16a that have not been subjected to setting for function commonalization with subsystems 17a that have been subjected to setting for function commonalization.

In addition, the CPU 2 displays a final report on a final screen 62 of the display 6 (step S9). The items to be indicated include the name, parameter, etc. of the subsystems added to each library through execution of a file, or replaced for function commonalization. Displaying the process content on the final screen 62 as the final report in this way allows the user to easily verify if the process for commonalizing functions of subsystems does not hinder the function of the original model.

After that, the user provides a command to the CPU 2 as necessary to cause the CPU 2 to code the model into the C code (step S10). At this time, subsystems, functions of which can be commonalized, have been replaced with common subsystems. Because common subsystems are coded into a common function, the size of the source code can be reduced when coded.

As has been described above, the clone function commonalizing device 1 according to the embodiment performs a detection step of detecting at least a plurality of subsystems, functions of which can be commonalized, from a model constituted by a block diagram. Thus, the functions of the detected clones, functions of which can be commonalized, can be commonalized. Consequently, the size of the source code can be reduced when the model is coded.

In addition, the clone function commonalizing device 1 according to the embodiment further includes an output step of outputting the results of the detection performed in the detection step. Thus, the detection results can be indicated to the user, which allows the user to select clones, functions of which to be commonalized, as appropriate on the basis of the detection results. In addition, even functions of clones that it is determined cannot be commonalized can be processed by the user as appropriate to be commonalized. Consequently, functions of clones can be adequately commonalized through verification by the user, and thus the size of the source code can be more effectively reduced.

With the clone function commonalizing device 1 according to the embodiment, in addition, a plurality of subsystems, functions of which can be commonalized with a function of a candidate for a subsystem registered in each library, are extracted from a model as clones, functions of which can be commonalized. Thus, the processing time for detecting clones can be shortened compared to a case where the library is not utilized.

With the clone function commonalizing device 1 according to the embodiment, in addition, the first library is set in advance separately from the model. Thus, subsystems verified in advance can be utilized. Consequently, it is not necessary to verify the subsystems when verifying whether the model in which clones have been replaced for function commonalization maintains its original function. Therefore, the verification time can be shortened, and the overall processing time can be shortened.

With the clone function commonalizing device 1 according to the embodiment, in addition, the detection section 20 automatically prepares a second library. Thus, automation of detection of clones can be promoted.

With the clone function commonalizing device 1 according to the embodiment, in addition, as illustrated in FIGS. 6A and 6B, a plurality of subsystems with the same function are detected as the subsystem, functions of which can be commonalized. Thus, functions of a larger number of clones can be commonalized compared to a case where subsystems with the same function but with different configurations are determined as subsystems, functions of which cannot be commonalized. Consequently, the size of the source code can be further reduced when the model is coded.

With the clone function commonalizing device 1 according to the embodiment, in addition, as illustrated in FIGS. 5A and 5B, a plurality of subsystems, functions of which can be commonalized by changing a parameter, are detected as the subsystem, functions of which can be commonalized. Thus, functions of a larger number of clones can be commonalized compared to a case where such subsystems are determined as subsystems, functions of which cannot be commonalized without changing a parameter. Consequently, the size of the source code can be further reduced when the model is coded.

With the clone function commonalizing device 1 according to the embodiment, in addition, as illustrated in FIG. 4, a plurality of subsystems that are the same in number of input and output ports but that are different only in operator are detected as subsystems, functions of which cannot be commonalized. Thus, it is possible to prevent subsystems, functions of which cannot be commonalized, from being erroneously detected as the subsystems, functions of which can be commonalized, and the processing time for detecting clones can be shortened.

With the clone function commonalizing device 1 according to the embodiment, in addition, a plurality of subsystems with different data types are detected as subsystems, functions of which cannot be commonalized. Thus, it is possible to prevent subsystems, functions of which cannot be commonalized, from being erroneously detected as the subsystems, functions of which can be commonalized, and the processing time for detecting clones can be shortened.

With the clone function commonalizing device 1 according to the embodiment, in addition, a block that does not affect a function is deleted before detecting subsystems, functions of which can be commonalized. Thus, even functions of subsystems with different configurations due to a block that does not affect a function may be commonalized. Consequently, functions of a larger number of clones can be commonalized, and the size of the source code can be further reduced when the model is coded.

With the clone function commonalizing device 1 according to the embodiment, in addition, subsystems in levels other than the uppermost level are deleted from the detection results so that only a subsystem in the uppermost level remains in the detection results. Thus, preparation of overlapping source codes by coding subsystems in different levels can be prevented. Therefore, the size of the source code can be further reduced when the model is coded.

With the clone function commonalizing device 1 according to the embodiment, in addition, the detection results include predetermined information about a determination as to whether or not the functions of the subsystems can be commonalized. Thus, the user can reference the detection results to determine whether or not to commonalize functions of subsystems. Consequently, functions of clones can be adequately commonalized through verification by the user, and thus the size of the source code can be more effectively reduced.

With the clone function commonalizing device 1 according to the embodiment, in addition, functions of a plurality of subsystems selected by the user, which are at least some of the plurality of subsystems detected as subsystems, functions of which can be commonalized, can be commonalized when coded. Consequently, the size of the source code can be reduced when the model is coded.

The clone function commonalizing device 1 according to the embodiment described above adopts semi-automatic processing in which, after the detection step is finished, an interim report is displayed on the display in the output step to allow the user to select subsystems, functions of which to be commonalized, and the subsystems are automatically replaced in the function commonalizing step. However, the present invention is not limited thereto. For example, the clone function commonalizing device 1 may adopt automatic processing in which, after the detection step is finished, subsystems that meet predetermined conditions for function commonalization are automatically replaced in the function commonalizing step. Alternatively, detection may be executed in the detection step, data may be kept as they are, and the data may be output when a reference request is provided from the outside.

In addition, the clone function commonalizing device 1 according to the embodiment includes, as libraries, the first library set in advance by the user, and the second library extracted from the target model by the clone function commonalizing device 1 to be added. However, the clone function commonalizing device 1 is not limited to having the two types of libraries. For example, the clone function commonalizing device 1 may have one or neither of the two types of libraries, or may have a library that is different from the first library and the second library.

The process operation according to the embodiment discussed above is specifically executed by the CPU 2, and may be achieved by supplying the CPU 2 with a recording medium that stores a software program for implementing the function discussed above so that the CPU 2 reads and executes the program stored in the recording medium. In this case, the function of the embodiment discussed above is implemented by the program read from the recording medium itself, and the program itself and the recording medium that stores the program constitute the present invention.

In the embodiment, in addition, the ROM 4 is a computer-readable recording medium, and the program is stored in the ROM 4. However, the present invention is not limited thereto. The program may be stored in any computer-readable recording medium. For example, an HDD, an external storage device, a recording disk, etc. may also be used as the recording medium for supplying the program.

### EXAMPLES

### Comparative Example

A model with 9716 blocks was manually processed for function commonalization as much as possible, and the model was coded. As a result, a code with 8287 lines was generated.

### Example 1

The model which had been manually processed for function commonalization in Comparative Example was processed for function commonalization by the clone function commonalizing device 1, and the model was coded. As a result, a code with 8018 lines was generated. Thus, the code was reduced by 269 lines compared to Comparative Example, which resulted in a reduction of 3.35%.

### Example 2

A comparison was made between the number of code lines generated in the case where a model that had not been processed for function commonalization at all was coded and the number of code lines generated in the case where a model that had been processed for function commonalization by the clone function commonalizing device 1 was coded. Then, the example resulted in a reduction in number of code lines of about 10%.

Thus, a reduction of more than 3% was achieved for a model manually processed for function commonalization as much as possible, not to mention the effect for a model that had not been processed for function commonalization at all. Thus, it turned out that the clone function commonalizing device 1 achieved function commonalization with higher accuracy than that achieved manually.

1. A clone detection method comprising:
a detection step of detecting at least a plurality of subsystems, functions of which can be commonalized, from a model constituted by a block diagram and having a plurality of subsystems each composed of an input port, an output port, and a block connected between the input port and the output port, the detection step being performed by a control section.

2. The clone detection method according to claim 1, further comprising:
an output step of outputting results of the detection performed in the detection step, the output step being performed by the control section.

3. The clone detection method according to claim 1, wherein
the detection step performed by the control section includes extracting a plurality of subsystems, functions of which can be commonalized with a function of a candidate for a subsystem registered in a library, from the model as the plurality of subsystems, functions of which can be commonalized.

4. The clone detection method according to claim 3, wherein
the library includes subsystems set in advance separately from the model.

5. The clone detection method according to claim 3, wherein
the library includes a plurality of subsystems, functions of which can be commonalized, the plurality of subsystems being extracted from the model and registered in the library by the control section.

6. The clone detection method according to claim 1, wherein
the detection step performed by the control section includes detecting a plurality of subsystems with the same function as the plurality of subsystems, functions of which can be commonalized.

7. The clone detection method according to claim 1, wherein
the detection step performed by the control section includes detecting a plurality of subsystems having respective blocks, functions of which can be commonalized by changing a parameter, as the plurality of subsystems that can be commonalized.

8. The clone detection method according to claim 1, wherein
the detection step performed by the control section includes detecting a plurality of subsystems having respective blocks that are the same in number of input and output ports but that are different only in operator as a plurality of subsystems, functions of which cannot be commonalized.

9. The clone detection method according to claim 1, wherein
the detection step performed by the control section includes detecting a plurality of subsystems having respective blocks with different data types as a plurality of subsystems, functions of which cannot be commonalized.

10. The clone detection method according to claim 1, wherein
the detection step performed by the control section includes deleting a block that does not affect a function from each subsystem in the model before detecting a plurality of subsystems, functions of which can be commonalized.

11. The clone detection method according to claim 1, wherein
the detection step performed by the control section includes in the case where the plurality of subsystems in the model have a hierarchical structure and it is detected that functions of the subsystems in different levels can be commonalized, deleting subsystems in levels other than the uppermost level from the detection results so that only a subsystem in the uppermost level remains in the detection results.

12. The clone detection method according to claim 2, wherein
the detection results include predetermined information about a determination as to whether or not functions of subsystems can be commonalized.

13. A clone detection program that causes a computer to execute the steps of the clone detection method according to claim 1.

14. A computer-readable recording medium that stores the clone detection program that causes a computer to execute the steps of the clone detection method according to claim 13.

15. A clone function commonalizing method, comprising:
the steps of the clone detection method according to claim 1; and
a function commonalizing step of setting a plurality of subsystems, which are at least some of the subsystems detected in the detection step as the plurality of subsystems, functions of which can be commonalized, such that functions of the at least some of the subsystems are commonalized when coded, the step being performed by the control section.

16. A clone function commonalizing program that causes a computer to execute the steps of the clone function commonalizing method according to claim 15.

17. A computer-readable recording medium that stores the clone function commonalizing program that causes a computer to execute the steps of the clone function commonalizing method according to claim 16.

18. The clone detection method according to claim 2, wherein
the detection step performed by the control section includes extracting a plurality of subsystems, functions of which can be commonalized with a function of a candidate for a subsystem registered in a library, from the model as the plurality of subsystems, functions of which can be commonalized.

19. The clone detection method according to claim 18, wherein
the library includes subsystems set in advance separately from the model.

20. The clone detection method according to claim 4, wherein
the library includes a plurality of subsystems, functions of which can be commonalized, the plurality of subsystems being extracted from the model and registered in the library by the control section.
